(19) United States
(12) Patent Application Publication
(10) Pub. No.: US 2002/0030168 A1
(43) Pub. Date: Mar. 14, 2002

(54) Energy regenerating device

(76) Inventor: Gabriel Martinez Martin, Palma de Mallorca (ES)

Correspondence Address: Clifford J. Mass, Ladas & Parry, 26 West 61 Street, New York, NY, 10023, US

(21) Appl. No.: 09/886,946

(22) Filed: Jun. 21, 2001

(30) Foreign Application Priority Data
Jun. 27, 2000 (ES) U 200001719

(51) Int. Cl. G21G 4/00

(52) U.S. Cl. 250/493.1

(57) ABSTRACT

An energy regenerating device, applicable over audio and video supports, as well as ron the corresponding playing equipment, characterized in that it consists of an aluminum body (1) with a conical shape and weighing approximately 80 g and having a base diameter of 5.5 cm, a height of 4.4 cm and an apothem of 4.4 cm., and a perforation (3) in the centre of its base, internally adopting a spiral or helicoidal shape with a decreasing diameter in an ascending vertical direction, the device likewise having a second part made of wood which acts as a support for part (1), having a cylindrical shape and presenting 5.5 centimeters of diameter and 1.5 centimeters of height.

### DESCRIPTION

An energy regenerating device, applicable over audio and video supports, as well as on the corresponding playing equipment.

### PURPOSE OF THE INVENTION

This descriptive report refers to a utility model application for an energy regenerating device applicable over audio and video supports, as well as on the corresponding playing equipment, whose purpose lies in the fact that when applied over sound and image reproduction devices, it significantly improves the audition or vision of that reproduced.

### FIELD OF THE INVENTION

This invention is applicable to the industry that manufactures equipment, devices and accessories for the video and audio industry.

### BACKGROUND

The applicant is currently aware of the existence of different sound and video support cleaning items, initially configured as sponges or brushes which combined with the movement of the support, achieve a gradual cleaning thereof.

Later on, the applicant learned about the use of liquids containing different substances, which on being applied over the disc surface with a sponge, cleans it, without improving the loss of sound.

Also, the applicant knows about the existence of record playing equipment head cleaners, such as those for CD readers, cassette readers and video tape readers.

In all cases, the purpose of these cleaning tapes is to partially eliminate the ferric deposit, or that of another nature, which gradually forms on the reading heads of the image and/or sound producing signals.

In all cases, the cleaning performed improves to a greater or lesser extent the audition and vision, having it been proved that these items partially deteriorate the heads.

The obvious solution to the current problem would be to have an apparatus; device or component that directly acted over record playing equipment, as well as the reproducing components themselves, carriers of the video and audio producing signals, without causing any kind of damage to their integrity.

However, at present, the applicant has no knowledge that such a device, having all the characteristics previously identified as ideal, exists.

### DESCRIPTION OF THE INVENTION

The energy regenerating device applicable over audio and video supports, as well as to the corresponding playing equipment proposed by the invention, is in itself an obvious novelty in its field of application, bringing together the characteristics of improving, in a progressive way, both the audition and vision of the video reproducing components, as well as of the equipment where these components acting as supports for later audition or viewing are introduced.

More specifically, the energy regenerating device applicable over audio and video supports, as well as on the corresponding playing equipment, purpose of the invention, is constituted by a conical body made of aluminium, weighing 80 g, being totally solid and having a circular perforation in its base, with spiral striations on its walls and with an inwardly decreasing diameter.

The invention acts in conjunction with a supportive part thereof, adopting a flat based circular shape and configured as a wooden cylinder.

By fitting the part consisting of the conical pyramid over the support and these in turn, over the component to be regenerated, these gradually act over the audition and viewing of the elements

### DESCRIPTION OF THE DRAWINGS

To complement the description being made and to permit a better understanding of the characteristics of the invention, a set of plans illustrating, but not limiting the invention, are attached to this descriptive report, where

FIG. 1 shows an elevation view of the object of the invention regarding an energy regenerating device, applicable over audio and video supports, as well as to the corresponding playing equipment.

FIG. 2 shows a plan view and front elevation of the support acting in harmonic combination with the object represented in FIG. 1.

FIG. 3 shows the objects represented in FIGS. 1 and 2, incorporated over a sound reproduction apparatus so as to act upon it.

FIG. 4 shows a plan view through the lower area or base of the object of the invention represented in FIG. 1.

### PREFERRED EMBODIMENT OF THE INVENTION

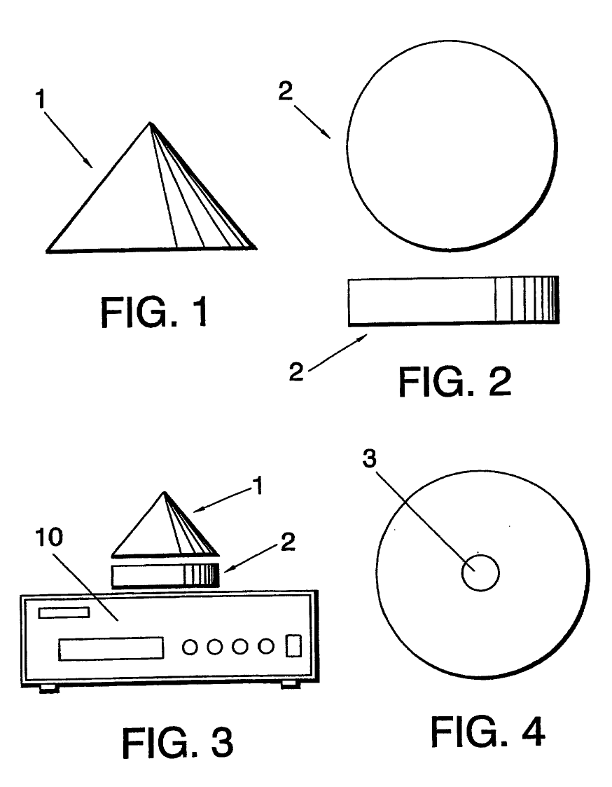

In the light of these figures and specifically FIG. 1, it may be observed how the energy regenerating device applicable over audio and video supports, as well as to the corresponding playing equipment is constituted by a conical body (1) manufactured in aluminium, whose base diameter is 5.5 cm and with a height of 3.45 cm and an apothem of 4.4 cm. The piece is solid, weighing approximately 80 g and having at the centre of its base a perforation (3), the internal walls of which have a spiral or helicoidal configuration with a gradual decrease of its width in an ascending vertical direction.

In harmonic combination with the conical piece (1), a wooden piece (2) is used which has a circular base and cylindrical shape with a diameter at the base of 5.5 centimeters, similar to that of the conical pyramid (1), and a height of 1.15 centimeters.

The conical piece (1) placed on its perforated base (3) is situated over the surface of piece (2) the latter, in turn, over any component to be regenerated, as shown in FIG. 3, on a conventional player device (10).

It is not considered necessary to extend this description further for any expert in the matter to fully understand the scope of the invention and the benefits derived from it.

The materials, shape, size and arrangement of the components may be varied, provided such changes do not alter the essentials of the invention.

The terms included in this report, should always be interpreted in the widest and non-limiting sense.

1.- An energy regenerating device, applicable over audio and video supports, as well as ron the corresponding playing equipment, characterised in that it consists of an aluminium body (1) with a conical shape and weighing approximately 80 g and having a base diameter of 5.5 cm, a height of 4.4 cm and an apothem of 4.4 cm., and a perforation (3) in the centre of its base, internally adopting a spiral or helicoidal shape with a decreasing diameter in an ascending vertical direction, the device likewise having a second part made of wood which acts as a support for part (1), having a cylindrical shape and presenting 5.5 centimeters of diameter and 1.5 centimeters of height.

2.- An energy regenerating device applicable over audio and video supports, as well as on the corresponding playing equipment, according to the first claim, characterised in that the conical part (1) should be incorporated over the surface of part (2) and both joined to each other over the component to be regenerated.
